(19) United States
(12) Patent Application Publication
(10) Pub. No.: US 2011/0141731 A1
(43) Pub. Date: Jun. 16, 2011

(54) REFLECTION-TYPE LIGHT-EMITTING ASSEMBLY

(75) Inventor: Chung-Min Chang, Jhubei City (TW)

(73) Assignee: Power Light Tech. Co., Ltd., Jhubei City (TW)

(21) Appl. No.: 12/825,526

(22) Filed: Jun. 29, 2010

(30) Foreign Application Priority Data
Dec. 11, 2009 (TW) 098142388

(51) Int. Cl. F21V 1/00

(52) U.S. Cl. 362/235

(57) ABSTRACT

A reflection-type light-emitting assembly is provided. The reflection-type light-emitting assembly includes a reflector and a plurality of light-emitting elements. The reflector has a concave-shape body and a supporter. The supporter is formed by extending the rim of the concave-shape body toward the center thereof, so as to form a light-emitting opening of the reflector. The light-emitting elements are arranged on the supporter. Light rays emitted by the light-emitting elements fall on a reflecting surface of the reflector and then reflect off the reflecting surface to thereby exit the light-emitting opening. The light rays reflected off the reflecting surface and out the reflector are relatively soft rather than glaringly uncomfortable to the human eyes.

### BACKGROUND OF THE INVENTION

1. Field of the Invention

The present invention relates to reflection-type light-emitting assemblies, and more particularly, to a reflection-type light-emitting assembly for use with a light-emitting diode lamp.

2. Description of the Prior Art

In general, there are two categories of light sources for lamps, namely point light sources and linear light sources. Examples of point light sources are a tungsten filament lamp and a compact fluorescent lamp. An example of linear light sources is an incandescent lamp. The aforesaid lamps are disadvantageously bulky and power-consuming and contain pollutants. By contrast, light-emitting diodes are advantageously power-efficient, collision-proof, and pollutant-free. Hence, in recent years we have seen unceasing R&D and subsequent application of light-emitting diodes to illumination lamps. Given the ever-increasing efficiency of the light emission of light-emitting diodes, light-emitting diode lamps will be the foremost illumination source in the future.

A light-emitting diode is a directional light source and thus its light-emitting angle cannot meet the requirements for lamp design in the absence of special optical design. In general, there are two optical designs in light-emitting diode lamps, namely straight-downward-type and reflection-type. The U.S. Pat. No. 6,502,956, entitled Light Emitting Diode Lamp with Individual LED Lenses, proposes a straight-downward-type lamp, comprising a plurality of light-emitting diodes (LEDs) mounted to a circuit board. Although LEDs increase the luminosity of light output in the light-emitting diode lamps disclosed in U.S. Pat. No. 6,502,956, when users closely observe the light-emitting diode lamps, they discover that the light-emitting diode lamps tend to resemble a group of individual light sources as opposed to a uniform surface light source, because each of the LEDs is itself a point light source.

In an attempt to solve the above problem, the reflection-type optical design was introduced to create a tailor-made surface light source. FIG. 1 depicts a schematic view of a lighting lamp structure disclosed in Taiwan Utility Model Patent No. M354038.As shown in the drawing, the patented lighting lamp structure comprises: a lamp base 1 inwardly defined with reflection regions 11 that are concave and arc-shaped; a reflection portion 12 provided at the center of each of the reflection regions 11 and tapered; and light sources 13 positioned opposite the reflection portions 12, respectively, wherein light rays emitted from the light sources 13 completely fall on the reflection portions 12 to thereby reflect therefrom. However, with the light sources 13 being centrally provided in the lighting lamp, it is necessary to provide a carrying mechanism 14 at the center of the lighting lamp. Furthermore, the carrying mechanism 14 is, as a whole, positioned in the way of the path of the light rays emitted from the light sources 13 and thereby blocks a portion of the light rays, and as a consequence, a significant portion of the light rays cannot be effectively emitted from the lighting lamp.

### BRIEF SUMMARY OF THE INVENTION

The present invention provides a reflection-type light-emitting assembly comprising a reflector with a reflecting surface such that light rays reflect off the reflecting surface and exit the reflector to thereby create a tailor-made surface light source.

The present invention provides a reflection-type light-emitting assembly comprising a supporter formed by extending the rim of the reflector to thereby prevent the supporter from being positioned in the way of the path of outbound light rays and thus enhance utilization of light rays.

To achieve the above and other objectives, the present invention provides a reflection-type light-emitting assembly, comprising: a reflector having a concave-shape body and a supporter, the concave-shape body being inwardly defined with a reflecting surface, and the supporter being formed by extending a rim of the concave-shape body toward a center thereof, so as to form a light-emitting opening of the reflector; and a plurality of light-emitting elements arranged on the supporter, wherein light rays emitted from the light-emitting elements fall on the reflecting surface and then exit the light-emitting opening.

Implementation of the present invention at least involves the following inventive steps:

1. A tailor-made uniform surface light source can be created, because light rays reflect off the reflecting surface before exiting the reflector.

2. The supporter is not positioned in the way of the path of outbound light rays and thus enhances utilization of light rays because the supporter is formed by extending the rim of the reflector toward the center thereof.

### BRIEF DESCRIPTION OF THE SEVERAL VIEWS OF THE DRAWINGS

The invention as well as a preferred mode of use and advantages thereof will be best understood by referring to the following detailed description of the illustrative embodiment in conjunction with the accompanying drawings, wherein:

FIG. 1 is a schematic view of a lighting lamp structure disclosed in Taiwan Utility Model Patent No. M354038;

FIG. 2 is a perspective view of an embodiment of a reflection-type light-emitting assembly according to the present invention;

FIG. 3A is a cross-sectional view of the embodiment of the reflection-type light-emitting assembly taken along line A-A of FIG. 2;

FIG. 3B is another cross-sectional view of the embodiment of the reflection-type light-emitting assembly taken along line A-A of FIG. 2;

FIG. 3C is yet another cross-sectional view of the embodiment of the reflection-type light-emitting assembly taken along line A-A of FIG. 2;

FIG. 4A is a schematic view of an embodiment of light-emitting elements arranged on a supporter according to the present invention; and

FIG. 4B is a schematic view of another embodiment of the light-emitting elements arranged on the supporter according to the present invention.

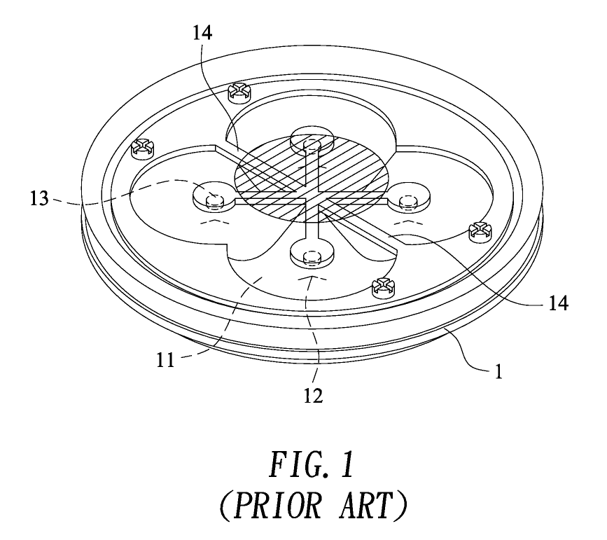

### DETAILED DESCRIPTION OF THE INVENTION

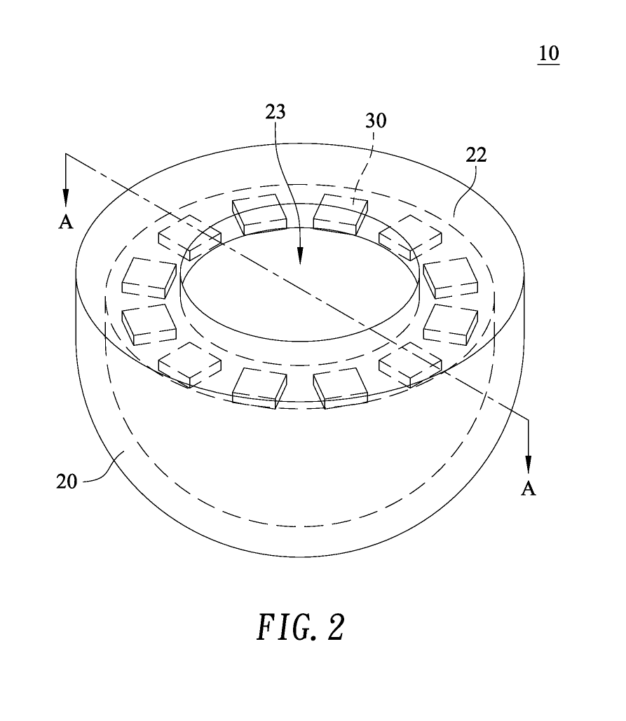

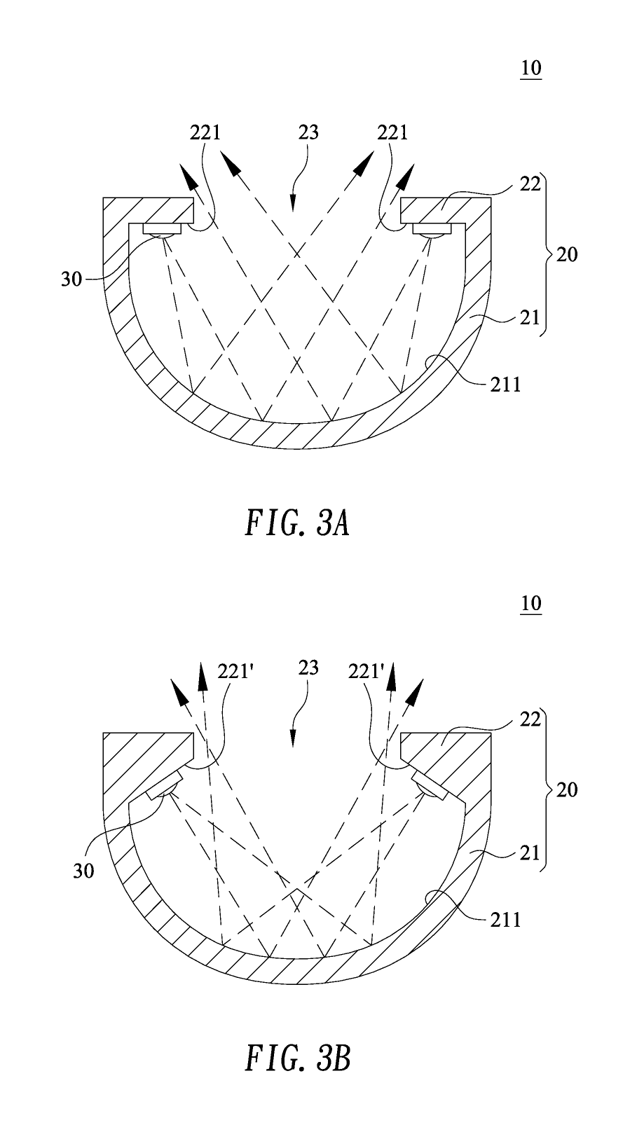

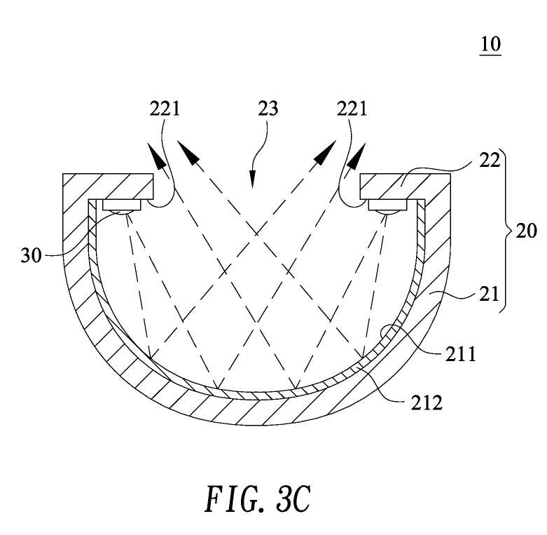

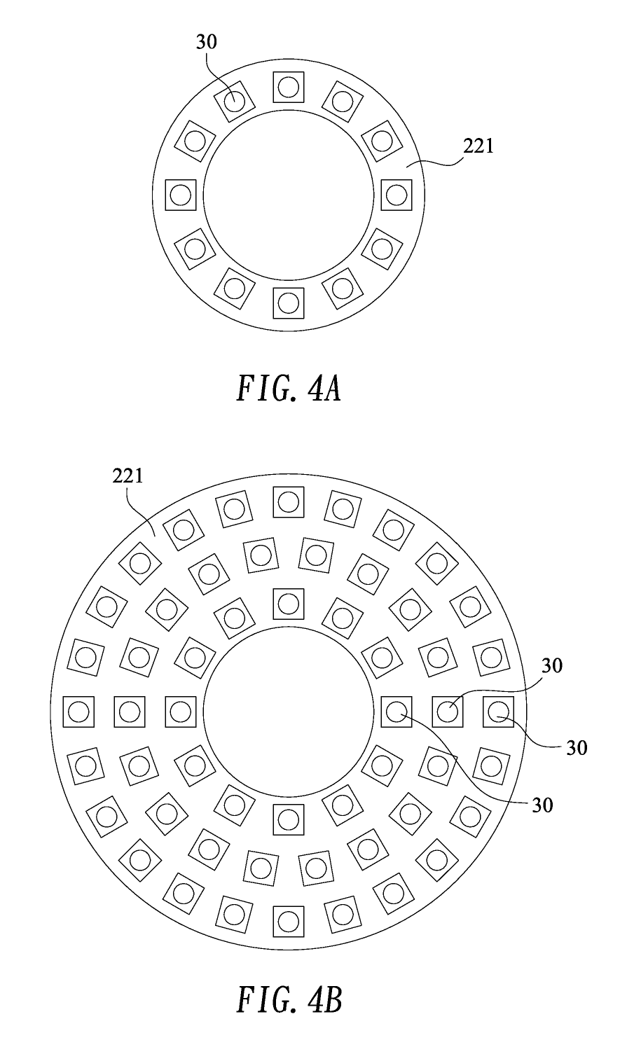

FIG. 2 is a perspective view of an embodiment of a reflection-type light-emitting assembly 10 according to the present invention. FIG. 3A is a cross-sectional view of the embodiment of the reflection-type light-emitting assembly 10 taken along line A-A of FIG. 2. FIG. 3B is another cross-sectional view of the embodiment of the reflection-type light-emitting assembly 10 taken along line A-A of FIG. 2. FIG. 3C is yet another cross-sectional view of the embodiment of the reflection-type light-emitting assembly 10 taken along line A-A of FIG. 2. FIG. 4A is a schematic view of an embodiment of light-emitting elements 30 arranged on a supporter 22 according to the present invention. FIG. 4B is a schematic view of another embodiment of the light-emitting elements 30 arranged on the supporter 22 according to the present invention.

Referring to FIG. 2 and FIG. 3A, in the embodiment, the reflection-type light-emitting assembly 10 includes a reflector 20 and a plurality of said light-emitting elements 30.

Referring to FIG. 3A through FIG. 3C, the reflector 20 has a concave-shape body 21 and the supporter 22. The reflector 20 is made of a material characterized by reflectivity such that light rays reflect off the reflector 20 due to the reflectivity thereof.

Referring to FIG. 2, the reflector 20 is concave such that the reflector 20 has the concave-shape body 21, and the concave-shape body 21 is of a symmetrical shape but is not limited thereto. Preferably, given variations in optical design, the shape of the concave-shape body 21 can be subject to changes so as to meet the requirements for light pattern output.

The concave-shape body 21 is inwardly defined with a reflecting surface 211. In other words, the arciform inner surface of the concave-shape body 21 is defined with the reflecting surface 211. The reflecting surface 211 is a surface of curvature. The reflecting surface 211 is composed of the same reflective material as the reflector 20 is made of as shown in FIG. 3A and FIG. 3B. Alternatively, the inner surface of the concave-shape body 21 is covered with a light reflection layer 212 (as shown in FIG. 3C) to form the reflecting surface 211. The reflecting surface 211 is a smooth reflecting surface or a roughened reflecting surface such that light rays fall on the reflecting surface 211 and can efficiently reflect therefrom.

Referring to FIG. 2 through FIG. 3C, the supporter 22 is formed by extending horizontally the rim of the concave-shape body 21 toward the center thereof. Hence, the supporter 22 thus formed is flat and protrudes inward. The supporter 22 defines an opening of the concave-shape body 21, or, specifically speaking, a light-emitting opening 23 of the reflector 20.

Referring to FIG. 3A, the supporter 22 has a carrying surface 221 facing the inside of the concave-shape body 21, and the light-emitting elements 30 are disposed on the carrying surface 221 of the supporter 22. Light rays emitted by the light-emitting elements 30 fall on the reflecting surface 211 of the concave-shape body 21. Preferably, the concave-shape body 21 and the supporter 22 are integrally formed as a unitary structure, that is, the reflector 20. Hence, heat generated by the light-emitting elements 30 is dissipated by both the supporter 22 and the concave-shape body 21.

The carrying surface 221 is a horizontal surface shown in FIG. 3A and FIG. 3C or, alternatively, is replaced with a carrying surface 221′ which is a slanted surface as shown in FIG. 3B. Light rays emitted from the light-emitting elements 30 disposed on the carrying surface 221′ shown in FIG. 3B fall on the reflecting surface 211 at an incident angle different than those from the light-emitting elements 30 on the carrying surface 221 shown in FIG. 3A and FIG. 3C. Hence, variation in the angle of inclination of the carrying surface 221′ allows the direction in which a light ray is emitted from the reflector 20 to vary as needed.

In other words, the angle of inclination of the carrying surface 221′ of the supporter 22 is adjustable as needed such that the output light pattern of light rays emitted from the reflector 20 is variable.

The light-emitting elements 30 are characterized by directionality and exemplified by light-emitting diode elements which come in different colors as needed. Referring to FIG. 3A and FIG. 3B, light rays emitted by the light-emitting elements 30 fall on the reflecting surface 211 of the concave-shape body 21, reflect off the reflecting surface 211, and eventually exit the reflector 20 via the light-emitting opening 23 of the concave-shape body 21. Also, the supporter 22 is provided at the rim of the concave-shape body 21 and thus is not positioned in the way of the path of the outbound light rays to thereby enhance utilization of light rays.

Referring to FIG. 4A, the light-emitting elements 30 are arranged, into a circle, on the carrying surface 221 of the supporter 22 to form a light-emitting circle thereon. The light-emitting elements 30 can be arranged to form either a single light-emitting circle shown in FIG. 4A or concentric light-emitting circles shown in FIG. 4B so as to increase the luminosity of light output of the reflection-type light-emitting assembly 10. Preferably, the light-emitting elements 30 are equidistantly spaced apart to enable uniform distribution of light emitted from the reflector 20.

The foregoing embodiments are provided to illustrate and disclose the technical features of the present invention so as to enable persons skilled in the art to understand the disclosure of the present invention and implement the present invention accordingly, and are not intended to be restrictive of the scope of the present invention. Hence, all equivalent modifications and variations made to the foregoing embodiments without departing from the spirit and principles in the disclosure of the present invention should fall within the scope of the invention as set forth in the appended claims.

What is claimed is:

1. A reflection-type light-emitting assembly, comprising:
a reflector having a concave-shape body and a supporter, the concave-shape body being inwardly defined with a reflecting surface, and the supporter being formed by extending a rim of the concave-shape body toward a center thereof, so as to form a light-emitting opening of the reflector; and
a plurality of light-emitting elements arranged on the supporter, wherein light rays emitted from the light-emitting elements fall on the reflecting surface and then exit the light-emitting opening.

2. The reflection-type light-emitting assembly of claim 1, wherein the reflector is made of a material characterized by reflectivity.

3. The reflection-type light-emitting assembly of claim 1, wherein the reflecting surface is formed from a light reflection layer.

4. The reflection-type light-emitting assembly of claim 1, wherein the reflecting surface is a smooth reflecting surface.

5. The reflection-type light-emitting assembly of claim 1, wherein the reflecting surface is a roughened reflecting surface.

6. The reflection-type light-emitting assembly of claim 1, wherein the supporter has a carrying surface disposed thereon with the light-emitting elements so as for the light rays emitted from the light-emitting elements to fall on the reflecting surface.

7. The reflection-type light-emitting assembly of claim 1, wherein the light-emitting elements dissipate heat through the supporter and the concave-shape body.

8. The reflection-type light-emitting assembly of claim 1, wherein the light-emitting elements are equidistantly spaced apart.

9. The reflection-type light-emitting assembly of claim 1, wherein the light-emitting elements are arranged, into a circle, on the supporter to form a light-emitting circle.

10. The reflection-type light-emitting assembly of claim 1, wherein the light-emitting elements are arranged to form a single light-emitting circle.

11. The reflection-type light-emitting assembly of claim 1, wherein the light-emitting elements are arranged to form concentric light-emitting circles.

12. The reflection-type light-emitting assembly of claim 1, wherein the light-emitting elements are characterized by directionality.

13. The reflection-type light-emitting assembly of claim 1, wherein the light-emitting elements are light-emitting diode elements.
